(19) United States
(12) Patent Application Publication
(10) Pub. No.: US 2015/0243030 A1
(43) Pub. Date: Aug. 27, 2015

(54) METHOD TO CALIBRATE AN OPTICAL ARRAY, METHOD TO DISPLAY A PERIODIC CALIBRATION PATTERN AND A COMPUTER PROGRAM PRODUCT

(71) Applicant: LaVision GmbH, Goettingen (DE)

(72) Inventor: Karsten Pfeiffer, Goettingen (DE)

(21) Appl. No.: 14/629,835

(22) Filed: Feb. 24, 2015

(30) Foreign Application Priority Data
Feb. 27, 2014 (DE) 10 2014 102 634.9

(51) Int. Cl. G06T 7/00; G06T 11/20

(52) U.S. Cl. CPC G06T 7/0018; G06T 7/0042; G06T 11/20; G06T 2207/10004

(57) ABSTRACT

A method is provided to calibrate an optical array consisting of an image detector and an optical imaging unit to depict a measurement volume on the image detector. At least one image of a periodic calibration pattern within a measurement volume is recorded by the optical array and depicted on a display. The calibration pattern has pattern structure units that differ in respect of at least one pattern structure feature, and the pattern scale that is representative of sizes of the pattern structure units is variable. The method correlates positions of the recorded calibration pattern points with image points on which they are displayed. At least one of the pattern structure units is depicted with an optically differentiable auxiliary unit that depends on the current pattern scale, such that the pattern scale can be determined from the depiction features of at least one depicted auxiliary unit.

### BACKGROUND

1. Field of the Invention

The invention relates to a method to calibrate an optical array, consisting of an image detector and an optical imaging unit, used to display a measurement volume on the image detector, comprising recording by the optical array of at least one image of a periodic calibration pattern positioned within the measurement volume and depicted on a display of a mobile electronic device, wherein the calibration pattern is composed of pattern structure units differing in respect of at least one pattern structure feature, and the pattern scale that is representative of the sizes of the pattern structure units is variable, and correlation of the positions of the recorded calibration pattern points with the image points on which they are displayed.

The invention further relates to a method to depict a periodic calibration pattern on a display of a mobile electronic device, wherein the calibration pattern is composed of pattern structure units that differ in respect of at least one pattern structure feature, and the pattern scale that is representative of the sizes of the pattern structure units is variable, as well as to a computer program product comprising a storage medium, computer instructions saved on the storage medium for execution in a processing unit of a mobile electronic device, wherein the computer instructions, when they are executed in the processing unit, supply this display method.

2. Description of the Related Art

A method to calibrate an optical array is known from DE 195 36 297 C2, for example. In such methods, a calibration plate having a calibration pattern of known geometry is introduced into a measurement volume. By comparing the calibration pattern image depicted on the image detector of the optical array with the calibration pattern on the calibration plate, it is possible to correlate the recorded calibration pattern points to corresponding image points, and thereby to calibrate the optical array. In the calibration method known from DE 195 36 297 C2, the optical array comprises an illumination projector in addition to a camera system. The illumination projector projects a striped pattern onto the calibration plate located in the measurement volume, said calibration plate being equipped with a black-and-white striped pattern oriented approximately perpendicular to the projected pattern. This results in approximately square-shaped, bright points of light appearing on the calibration plate, the position in space of said points being determinable by the camera system. When this is done for various positions of the calibration plate in the measurement volume, it is possible to calibrate the camera projector system.

The necessity of having available a plurality of different calibration plate variants for various applications represents an additional expense for the hitherto known calibration methods. In addition, when an identical method is used in parallel, it is necessary to have available a plurality of a certain variant of calibration plate. This is disadvantageous especially with regard to the costs associated with these high-precision calibration plates.

This problem can be avoided by depicting the calibration pattern required in each case on the display of a mobile electronic device, such as a tablet. A corresponding method is already known from the generic patent CN 102968794 A. Instead of a calibration plate, this method introduces a tablet computer into the measurement volume of an optical array and the calibration pattern required to perform the calibration is depicted on the display of the computer. The calibration pattern in this case consists of six identical and repeating square calibration pattern units, each of which is formed by a round, black point and a white background. The fact that the absolute size of these points is known makes it possible to correlate the calibration pattern points recorded at different positions of the display within the measurement volume with the corresponding image points and thereby to calibrate the optical array. It is disadvantageous that the respective absolute size of the points depicted on the display must first be communicated to the optical array as this necessitates an additional work step, such as having a user enter the relevant information.

The problem to be solved by the present invention is to further develop a generic method to calibrate an optical array in such a way that calibration of the optical array can be performed automatically.

### SUMMARY OF THE INVENTION

This problem is solved in that at least one of the pattern structure units is depicted along with an optically differentiable auxiliary unit which depends on the respectively current pattern scale, so that the pattern scale can be determined from the depicted features of at least one depicted auxiliary unit.

The invention also provides a method to display such a calibration pattern as well as a computer program product that relates back to this method.

Depicting the auxiliary unit makes it possible to calibrate the optical array automatically, i.e. without any additional input from a user, as the automatic system can independently determine the pattern scale, which is a measure of the size of the pattern structure units. For example, the information regarding the pattern scale can be encoded in the coloring and/or shape and/or position of the auxiliary unit within the calibration pattern. Depicting an auxiliary unit at various positions within the pattern structure unit is an example of position-dependent encoding of the pattern scale. A single auxiliary unit can supply all of the pattern scale information. It is, however, equally possible to encode the pattern scale information by depicting multiple auxiliary units.

The invention enables a user to calibrate an optical array on the basis of a calibration pattern depicted on the display of a mobile electronic device. The user can initiate the depiction of the calibration pattern on a display directly on site, i.e. directly during calibration of the optical array; he can introduce this display into a suitable measurement volume of the optical array, and then perform calibration of the optical arrangement based on the calibration pattern depicted on the display. In each case, the periodic calibration pattern is composed of pattern structure units which differ in respect of at least one pattern structure feature, such as color or shape. A single periodic calibration pattern is composed of pattern structure units that are always proportional in size to one another. The sizes of the pattern structure units of a single periodic calibration pattern can vary, however.

The displays of contemporary mobile electronic devices, such as mobile phones, smartphones and tablets, are capable of depicting highly precise images since the pixels of the display can be reproduced with nanometer precision. It is advantageous to use mobile electronic devices whose displays have a pixel density of at least 100 dots per inch (DPI), and preferably even at least 125 DPI, and for optimal results, at least 150 DPI.

A further development of the invention provides that the positions of the calibration pattern points be adjusted for refraction effects resulting from a transparent protective layer in front of the calibration pattern points. For example, this protective layer can be a glass panel located in front of the transistors in the display that produce the image. The refraction effects caused by this panel can be appropriately taken into account during calibration of the optical array, as the panel thickness and index of refraction are known. For this purpose, a person skilled in the art is familiar with a range of mathematical methods, such as bundle adjustment calculations.

In a preferred embodiment of the invention, the calibration pattern is depicted on the display such that a pattern structure unit is depicted with a reference marking that is optically differentiable, independent of the pattern scale, and in a fixed position relative to the respective edges of the display, and the at least one auxiliary unit is depicted within a pattern structure unit that is fixed relative to the reference marking. This simplifies the process of locating the auxiliary units during automatic calibration. It is not necessary for a corresponding detection algorithm to evaluate the entire calibration pattern being depicted to find an auxiliary unit. Rather, the algorithm can directly evaluate only those pattern structure units in which the auxiliary units are depicted. This is done in that the detection algorithm identifies solely the reference marking and, based on a fixed positional relationship, can directly locate the pattern structure units that are depicted with auxiliary units.

An especially preferred embodiment provides that multiple auxiliary units are depicted in pattern structure units placed at the same distance from the reference marking. This additionally simplifies the process of locating a pattern structure unit that contains an auxiliary unit, based on its relative position to the reference marking, as it is not necessary to define a parameter for each of these pattern structure units to describe their position relative to the reference marking. Rather, the position of all these pattern structure units can be determined from the position of the reference marking, using a single parameter, namely the distance of these pattern structure units from the reference marking. An especially preferred embodiment of the invention provides that the auxiliary unit is depicted in a pattern structure unit that has a simple geometric shape. This greatly simplifies the process of determining the position of the auxiliary unit within the pattern structure unit. Simple geometric shapes are, for example, squares or other rectangles, triangles, circles, simple polygons or crosses.

In the present invention it is especially preferably provided that the auxiliary unit consists of auxiliary unit elements, each of which is assigned a fixed position within the auxiliary unit. This allows the quantity of information encoded by an auxiliary unit to be further increased, since variations in the depiction of the auxiliary elements can also be used to encode pattern scale information. For example, a square auxiliary unit could be composed of nine auxiliary unit elements that are also square and are depicted as either white or black. In this case, an auxiliary unit placed at a fixed position within the pattern structure unit encodes different pattern scale information depending on which of the auxiliary unit elements is depicted as black or white.

A further development of the invention provides that the pattern structure units, the auxiliary unit and the auxiliary unit elements have an identical feature, but the reference marking does not have this feature. An example of such a feature can be the coloring or shape. This makes it easy for the reference marking to be detected by a corresponding detection algorithm. For example, the detection algorithm can easily distinguish between a round reference marking and square pattern structure units, auxiliary units and auxiliary unit elements.

In a further development of the invention it is advantageous that a value of at least one pattern parameter, such as the sizes or number of the pattern structure units depicted, is displayed outside the calibration pattern. This is advantageous as a human user can generally not draw any conclusions regarding the pattern scale of the calibration pattern depicted on the display from the depiction of the auxiliary units. A pattern parameter can be displayed in plain text outside the calibration pattern, for example in the form of decimal numbers and letters. For this purpose, the numbers and letters could be depicted, for example, on sections of the display that remain available and/or on an additional, external display.

An especially preferred embodiment of the invention provides that the pattern scale of the periodic calibration pattern to be depicted can be selected by making an input on an input unit, such as a touchscreen, on the mobile electronic device. This allows a user to vary the display of the periodic calibration pattern in order to adapt it to the requirements of the required calibration procedure. This is advantageous as some optical arrays can differ considerably with regard to their maximum attainable resolution. Moreover, the user can vary the pattern scale of the periodic calibration pattern on site, i.e. directly during calibration of the optical array, thereby adapting it to the prevailing conditions or even to spontaneously arising conditions.

A computer program product that supplies a display method in accordance with the invention is a separate subject of the present invention.

Further features and advantages of the invention result from the following specific description and the drawings.

### BRIEF DESCRIPTION OF THE DRAWINGS

FIG. 1 is a schematic representation of a calibration method in accordance with the invention.

FIG. 2 is a drawing of an example of a depiction generated on the display of a mobile electronic device by a preferred embodiment of the display method in accordance with the invention.

FIG. 3 is a drawing as per FIG. 2 that employs a different pattern scale.

### DETAILED DESCRIPTION

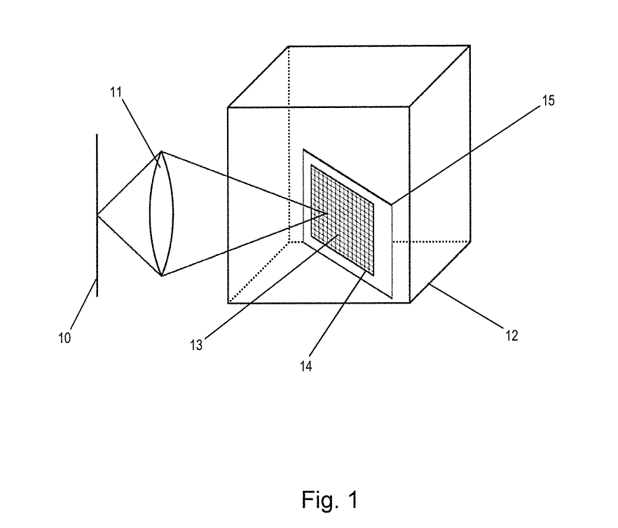

FIG. 1 shows a representation of the method in accordance with the invention to calibrate an optical array consisting of an image detector 10 and an optical imaging unit 11. The figure additionally shows that the optical imaging unit 11 depicts the points of a calibration pattern 13, located in a measurement volume 12, on the surface of the image detector 10. FIG. 1 also shows that the calibration pattern 13 is depicted on the display 14 of a mobile electronic device 15.

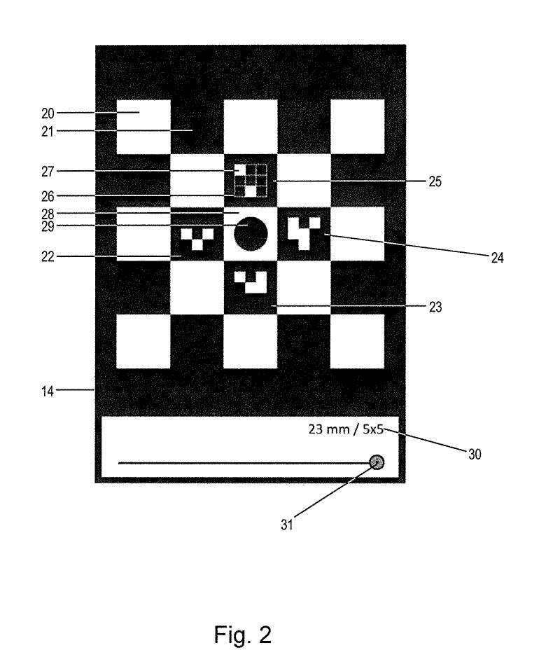

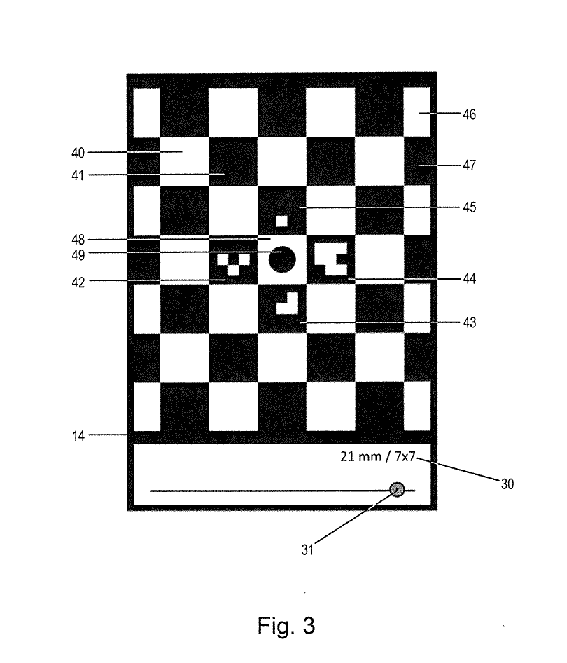

FIG. 2 is a drawing of an example of a depiction on the display 14 of a mobile electronic device that has been generated by a preferred embodiment of the display method in accordance with the invention. The periodic calibration pattern depicted on the display 14 of a mobile electronic device 15 is composed of pattern structure units 20, 21. The pattern structure units 22, 23, 24 and 25 additionally have an auxiliary unit 26. In FIG. 2, the displayed auxiliary units 26 each consist of nine square auxiliary unit elements 27 that are either black or white. In the pattern structure unit 25, the auxiliary unit 26 is shown with white dotted lines for illustration purposes. The central pattern structure unit 28 has a black, circular reference marking 29. FIG. 2 also shows the values of two pattern parameters, namely the size and number of the pattern structure units, in a display section 30, and a selection control 31. The setting of the selection control can be varied by making an input on a touch screen. This re-initiates the display method in accordance with the invention using a different pattern scale, while the position of the reference marking is kept constant relative to the edges of the display, and the position of the auxiliary units is kept constant relative to the reference marking. FIG. 3 is a drawing of a corresponding depiction on the display of a mobile electronic device.

The calibration pattern depicted in FIG. 3 has a different pattern scale than the calibration pattern depicted in FIG. 2 since the sizes of the pattern structure units 40, 41 are not identical to the sizes of the pattern structure units 20, 21. The black-and-white color coding of the auxiliary unit elements in the pattern structure units 43, 44, 45 therefore varies compared to the auxiliary unit elements of pattern structure units 23, 24, and 25. Furthermore, the depiction of the selection control 31 and of the pattern parameters in the display section 30 is adapted to the relevant calibration pattern depiction. FIG. 3 also shows a pattern structure unit with an auxiliary unit 42 and a central pattern structure unit 48 with a reference marking 49. The maximum number of pattern structure units that can be depicted is determined by their sizes and the size of the display 14. In the case illustrated in FIG. 3, the calibration pattern cannot be fully depicted on the display. For this reason, only partial pattern structure units 46, 47 are depicted along the edges of the display. In this case, the periodic part of the calibration pattern is defined solely by the pattern structure units that are depicted in full.

The embodiments discussed in the specific description and shown in the figures obviously represent merely illustrative embodiments of the present invention. In light of the present disclosure, a person skilled in the art has a broad spectrum of optional variations available.

### LIST OF REFERENCE NUMBERS

10 Image detector
11 Optical imaging unit
12 Measurement volume
13 Calibration pattern
14 Display
15 Mobile electronic device
20, 21 Pattern structure unit
22, 23, 24, 25 Pattern structure unit with auxiliary unit
26 Auxiliary unit
27 Auxiliary unit element
28 Pattern structure unit with reference marking
29 Reference marking
30 Display section with pattern parameter values
31 Selection control
40, 41 Pattern structure unit
42, 43, 44, 45 Pattern structure unit with auxiliary unit
46, 47 Partial pattern structure unit
48 Pattern structure unit with reference marking
49 Reference marking

What is claimed is:

1. A method to calibrate an optical array consisting of an image detector (10) and an optical imaging unit (11) used to depict a measurement volume (12) on the image detector (10),
comprising
recording by the optical array of at least one image of a periodic calibration pattern (13) depicted on the display (14) of a mobile electronic device (15) and positioned within a measurement volume (12)
wherein
the calibration pattern (13) is composed of pattern structure units (20, 21, 22, 23, 24, 25, 28, 40, 41, 42, 43, 44, 45, 48), which differ in respect of at least one pattern structure feature, and the pattern scale that is representative of the sizes of the pattern structure units (20, 21, 22, 23, 24, 25, 28, 40, 41, 42, 43, 44, 45, 48), is variable, and
correlation of the positions of the recorded calibration pattern points with the image points on which they are displayed, and wherein
at least one of the pattern structure units (20, 21, 22, 23, 24, 25, 28, 40, 41, 42, 43, 44, 45, 48) is depicted with an optically differentiable auxiliary unit (26) which depends on the respectively current pattern scale, such that the pattern scale can be determined from the depicted features of at least one depicted auxiliary unit (26).

2. The method of claim 1, wherein
the positions of the calibration pattern points are adjusted for refraction effects caused by a transparent protective layer in front of the calibration pattern points.

3. A method to depict a periodic calibration pattern (13) on a display (14) of a mobile electronic device (15), wherein the calibration pattern (13) consists of pattern structure units (20, 21, 22, 23, 24, 25, 28, 40, 41, 42, 43, 44, 45, 48) that differ in respect of at least one pattern structure feature, and the pattern scale that is representative of the sizes of the pattern structure units (20, 21, 22, 23, 24, 25, 28, 40, 41, 42, 43, 44, 45, 48) is variable, wherein
at least one of the pattern structure units (20, 21, 22, 23, 24, 25, 28, 40, 41, 42, 43, 44, 45, 48) is depicted with an optically differentiable auxiliary unit (26) that depends on the respectively current pattern scale, such that the pattern scale can be determined from depiction features of at least one depicted auxiliary unit (26).

4. The method of claim 3, wherein
the pattern structure unit (20, 21, 22, 23, 24, 25, 28, 40, 41, 42, 43, 44, 45, 48) is depicted with a reference marking (29, 49) that is optically differentiable, independent of the pattern scale, and positioned at a fixed location relative to the edges of the given display, and the at least one auxiliary unit (26) is depicted in a pattern structure unit (20, 21, 22, 23, 24, 25, 28, 40, 41, 42, 43, 44, 45, 48) that is fixed relative to the reference marking (29, 49).

5. The method of claim 4, wherein
multiple auxiliary units (26) are depicted in pattern structure units (20, 21, 22, 23, 24, 25, 28, 40, 41, 42, 43, 44, 45, 48) located at the same distance from the reference marking (29, 49).

6. The method of claim 3, wherein
the auxiliary unit (26) comprises auxiliary unit elements (27), to each of which is assigned a fixed position within the auxiliary unit (26).

7. The method of claim 6, wherein
the pattern structure units (20, 21, 22, 23, 24, 25, 28, 40, 41, 42, 43, 44, 45, 48), the auxiliary unit (26) and the auxiliary unit elements (27) have an identical feature, whereas the reference marking (29, 49) does not have this feature.

8. The method of claim 3,
characterized in that
a value of at least one pattern parameter is displayed outside of the calibration pattern (13).

9. The method of claim 3, wherein
the pattern scale of the periodic calibration pattern (13) to be depicted can be selected by making an input on an input unit of the mobile electronic device (15).

10. The method of claim 9, wherein
the input unit is designed as a touchscreen.

11. Computer program product,
comprising
a storage medium,
computer instructions, saved on the storage medium, to be executed in a processing unit of a mobile electronic device (15), wherein the computer instructions provide the display method of claim 3 when executed in the processing unit.
